(19) United States
(12) Patent Application Publication
(10) Pub. No.: US 2021/0286366 A1
(43) Pub. Date: Sep. 16, 2021

(54) MOVABLE OBJECT CONTROL DEVICE, MOVABLE OBJECT CONTROL METHOD AND STORAGE MEDIUM STORING PROGRAM

(71) Applicant: HONDA MOTOR CO., LTD., Tokyo (JP)

(72) Inventors: Shigeru INOUE, Wako-shi (JP); Hideki MATSUNAGA, Wako-shi (JP); Masamitsu TSUCHIYA, Wako-shi (JP); Kenji KOMORI, Wako-shi (JP); Takahiro KUREHASHI, Wako-shi (JP); Hiroki TANAKA, Wako-shi (JP)

(21) Appl. No.: 17/193,993

(22) Filed: Mar. 5, 2021

(30) Foreign Application Priority Data
Mar. 10, 2020 (JP) 2020-040664

(51) Int. Cl. G05D 1/02; G08G 1/0967; G08G 1/0965; B60W 30/09; B60W 30/18

(52) U.S. Cl. CPC G05D 1/0214; G05D 1/0276; G08G 1/096725; B60W 2720/106; B60W 30/09; B60W 30/18163; G08G 1/0965

(57) ABSTRACT

A movable object control device to appropriately collaborate with other movable objects comprises a processor including an event detection section detecting a possible event that influences a movable object of interest running, a communication section for communicating with other movable objects, an area determining section determining a presence area for each of plural action plans associated with the possible event detected by the event detection section, the presence area being an area where other movable objects are present with which the movable object of interest needs to communicate, an evaluation section evaluating communication between the movable object of interest and each of the other movable objects included in the presence area and an action plan determining section selecting an action plan to be performed from among the plural action plans based an evaluation result by the evaluation section.

### CROSS REFERENCE TO RELATED APPLICATIONS

This application claims the foreign priority benefit under 35 U.S.C. § 119 of Japanese Patent Application No. 2020-40664 filed on Mar. 10, 2020, the disclosure of which is incorporated herein by reference.

### TECHNICAL FIELD OF THE INVENTION

The present invention relates to a movable object control device and the like.

### BACKGROUND OF THE INVENTION

There has been a proposal on a so-called autonomous driving technology for a vehicle, which is intended to reduce driver's tasks and provide more safe and comfortable driving. WO2019/150454A discloses a technology for an autonomously driving vehicle to change its running lane, according to which a rearward driving vehicle, which is to run rearward of a driver's vehicle being autonomously driven after the driver's vehicle changes running lanes into a running lane on which the rearward driving vehicle is running, is selected based on a relative acceleration a on the driver's vehicle relative to the rearward driving vehicle, which is required for the driver's vehicle is to run at a speed substantially equal to a speed at which the rearward driving vehicle is running.

While a driver's vehicle is running, it is possible that a vehicle running in a wrong direction is quickly approaching the driver's vehicle from frontward of a driver's vehicle or such an emergency vehicle as an ambulance is approaching the driver's vehicle. When the driver's vehicle is in such a circumstance, it may be difficult for the driver's vehicle to keep itself from colliding with the approaching vehicle on its own. WO2019/150454A describes the technology on how to change lanes but does not describe a technology on how a driver's vehicle and other vehicles (other movable objects) drive in cooperation with each other in a circumstance where it is difficult for a driver's vehicle to avoid an accident on its own.

The present invention has an objective to provide a movable object control device and the like for having a movable object run in appropriate cooperation with other movable objects.

### SUMMARY OF THE INVENTION

In order to achieve the objective as described, the present invention has a feature of a movable object control device comprising a processor including an event detection section detecting a possible event that influences a movable object of interest running, a communication section for communicating with other movable objects, an area determining section determining a presence area for each of plural action plans associated with the possible event detected by the event detection section, the presence area being an area where other movable objects are present with which the movable object of interest needs to communicate, an evaluation section evaluating communication between the movable object of interest and each of the other movable objects included in the presence area and an action plan determining section selecting an action plan to be performed from among the plural action plans based an evaluation result by the evaluation section.

The present invention enables providing a movable object control device that works to properly collaborate with other movable objects.

### BRIEF DESCRIPTION OF THE DRAWINGS

FIG. 1 schematically illustrates a driving assistance system including a vehicle equipped with a control device of a first embodiment of the present invention.

FIG. 2 is a functional block diagram inclusive of the movable object control device.

FIG. 3 illustrates an example of a circumstance where a possible event occurs involving a vehicle that is equipped with the control device of the first embodiment and is running.

FIG. 4 describes a table listing five action plans that can be taken by the control device of the first embodiment when an event occurs in which there is an object ahead of a driver's vehicle.

FIG. 5A is a part of a flow chart of a control procedure to be performed by the control device of the first embodiment.

FIG. 5B is the rest of the flow chart of the control procedure following the part illustrated in FIG. 5A.

FIG. 6A shows a presence area where other vehicles are present, with which the control device of the first embodiment has to communicate for an action plan Pa.

FIG. 6B illustrates how the action plan Pa is performed by the control device of the first embodiment.

FIG. 7A shows a presence area where other vehicles are present, with which the control device of the first embodiment has to communicate for an action plan Pb.

FIG. 7B illustrates how the action plan Pb is performed by the control device of the first embodiment.

FIG. 8A shows a presence area where another vehicle is present, with which the control device of the first embodiment has to communicate for an action plan Pc.

FIG. 8B illustrates how the action plan Pc is performed by the control device of the first embodiment.

FIG. 9 shows a presence area where other vehicles are present, with which the control device of the first embodiment has to communicate for an action plan Pe.

FIG. 10A shows a presence area where other vehicles are present with which the driver's vehicle has to communicate for a predetermined action plan to be performed when an emergency vehicle is approaching the driver's vehicle from rearward of the driver's vehicle.

FIG. 10B illustrates how the predetermined action plan is performed when the emergency vehicle is approaching the driver's vehicle from rearward of the driver's vehicle.

FIG. 11A shows a different example of a circumstance near a driver's vehicle equipped with the control device of the first embodiment, the circumstance in which a different possible event occurs while the driver's vehicle is running.

FIG. 11B illustrates how a predetermined action plan is performed by the control device when the possible event occurs while the driver's vehicle is running.

FIG. 12 is a functional block diagram including a control device of a second embodiment of the present invention.

FIG. 13 is a flow chart of a control procedure to be performed by the control device of the second embodiment.

### DETAILED DESCRIPTION OF EMBODIMENT

### First Embodiment

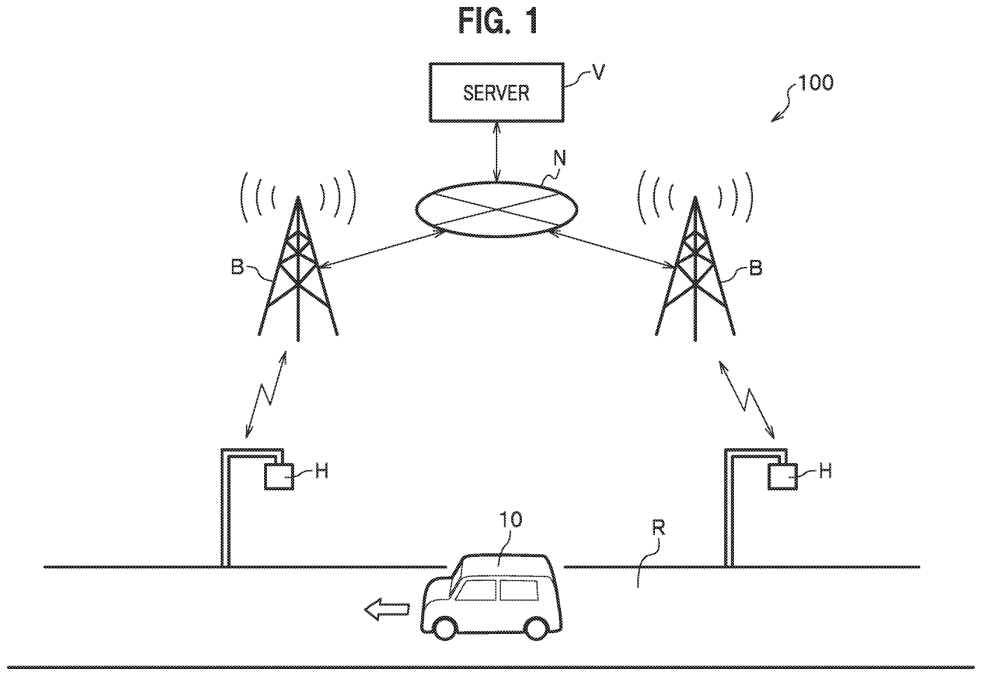

FIG. 1 schematically illustrates a driving assistance system 100 including a vehicle 10 (movable object) equipped with a movable object control device. Here, the word “assistance” means the driving assistance system 100 assisting the vehicle 10 with either a steering operation or an accelerating or decelerating operation, or both operations.

The driving assistance system 100 in an example as shown in FIG. 1 includes a server V and a vehicle 10. The server V receives, for example, information on a position or a state of the vehicle 10 through a roadside device H or a base station B. In addition, the server V is configured to prepare predetermined information to be used for driving assistance of the vehicle 10 and send the prepared information to the vehicle 10 through the base station B or the roadside device H.

The base station B is configured to relay information between the server V and the roadside device H or between the server V and the vehicle 10, through a network N. The roadside device H is configured to communicate with a vehicle nearby.

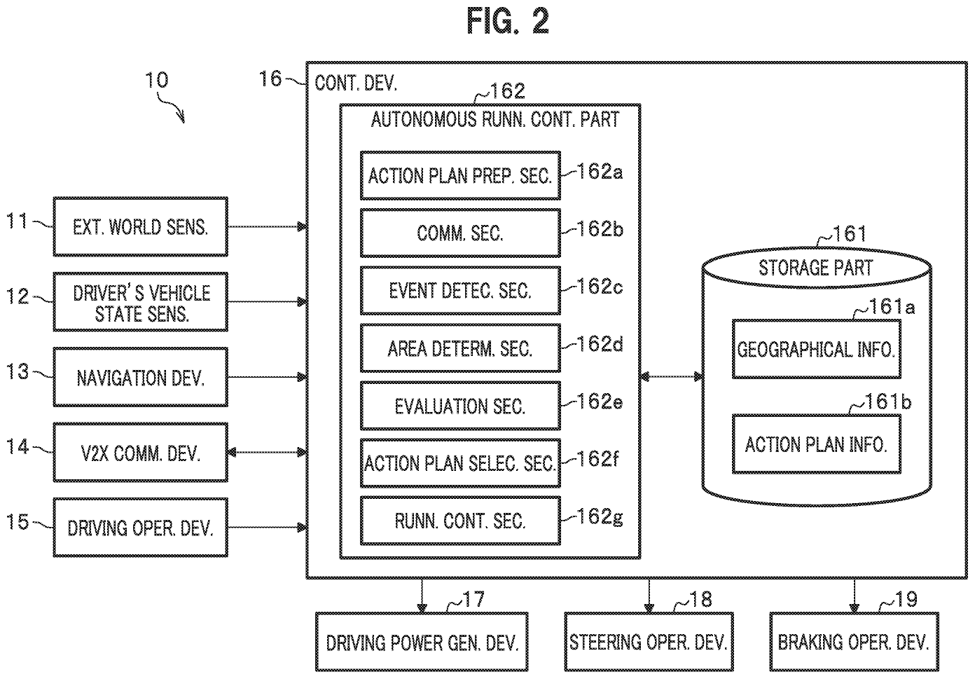

FIG. 2 is a functional block diagram inclusive of a control device 16.

As shown in FIG. 2, the vehicle 10 may comprise an external world sensor 11, a driver's vehicle state sensor 12, a navigation device 13, a V2X communication device 14 and a driving operation device 15. In addition to these devices, the vehicle 10 may further comprise the control device (movable object control device) 16, a driving power generating device 17, a steering operation device 18 and a braking operation device 19.

The external world sensor 11 may be configured to detect an object present near the vehicle 10. The external world sensor 11 may include a camera, a radar and a LiDAR (Light Detection and Ranging). The camera (not shown) takes an image of a surrounding area of the vehicle 10. There are several cameras attached to a front side, a rear side and lateral sides of the vehicle 10. A CMOS (Complementary Metal Oxide Semiconductor) camera or a CCD (Charge Coupled Device) camera may be used for the camera.

The radar (nor shown) radiates a radar wave toward an ahead-located vehicle frontward of the vehicle 10 and measures a distance to the object and a direction in which the object is present. The LiDAR (not shown) measures a distance to the object based on a time from when light is radiated to when scattered light after reflecting from the object is detected.

The driver's vehicle state sensor 12 may be configured to detect a predetermined state quantity indicative of a state of the vehicle 10. The driver's vehicle state sensor 12 may include a speed sensor, an acceleration sensor, a steering angle sensor, an inclination angle sensor and a yaw rate sensor, which are not shown.

Detected values by the driver's vehicle state sensor 12 are outputted to the control device 16.

The navigation device 13 may be configured to indicate a route from where the vehicle 10 is now to a destination designated by a user. The navigation device 13 may include a GNSS (Global Navigation Satellite System) receiver and a user interface, which are not shown. The user interface may include a touch-panel type display, a speaker and a microphone. In addition, the navigation device 13 determines a current position where the vehicle 10 is now based on a signal the GNSS receiver (not shown) receives and indicates the route from the current position to the destination designated by the user. The route as indicated in this way is notified to the user through the user interface (not shown).

The V2X communication device 14 has a function of performing vehicle-to-vehicle communication (so called, V2V communication) between the vehicle 10 and other vehicles located close to the vehicle 10. In addition, the V2X communication device 14 has a function of performing communication between the vehicle 10 and the roadside device H (as shown FIG. 1) as well. A signal received by the V2X communication device 14 is outputted to the control device 16.

The driving operation device 15 may be a device to be used for predetermined driving operations. The driving operation device 15 may be any of a steering wheel, a joystick, a button, a dial switch, a GUI (Graphical User Interface) and the like, which are not shown.

The control device 16 (ECU: Electronic Control Device) may control each of the devices in the vehicle 10. The “devices”, as is referred to here, may include the driving power generating device 17, the steering operation device 18 and the braking operation device 19.

The control device 16 is not shown as a hardware device and may include a CPU (Central Processing Unit), ROM (Read Only Memory), RAM (Random Access Memory) and electrical circuits for various interfaces.

The control device 16 may be configured to read a program for a control procedure to be performed stored in the ROM, load it into the RAM and have the CPU execute the program.

As shown in FIG. 2, the control device 16 includes a storage part 161 and an autonomous driving control part 162.

The storage part 161 stores data of geographical information 161a and action plan information 161b. The geographical information 161a includes information on a current position of the vehicle 10 on a map and a route for the vehicle 10, which is obtained or created by the navigation device 13. The action plan information 161b is information on an action plan associated with a possible event. Details of the action plan information 161b are described later.

The autonomous driving control section 162 may include an action plan preparing section 162a, a communication section 162b, an event detection section 162c, an area determining section 162d, an evaluation section 162e, an action plan selecting section 162f and a running control section 162g.

The action plan preparing section 162a prepares plural action plans associated with the possible event that has an influence on the vehicle 10 running. The possible event may be an event such as the driver's vehicle encountering of a vehicle running in a wrong direction, an emergency vehicle (a fire-fighting vehicle, an ambulance, a police vehicle and the like) approaching the driver's vehicle, a person or an animal suddenly running right in front of the vehicle 10, the driver's vehicle encountering a disabled vehicle, falling rocks or landslide, and the like.

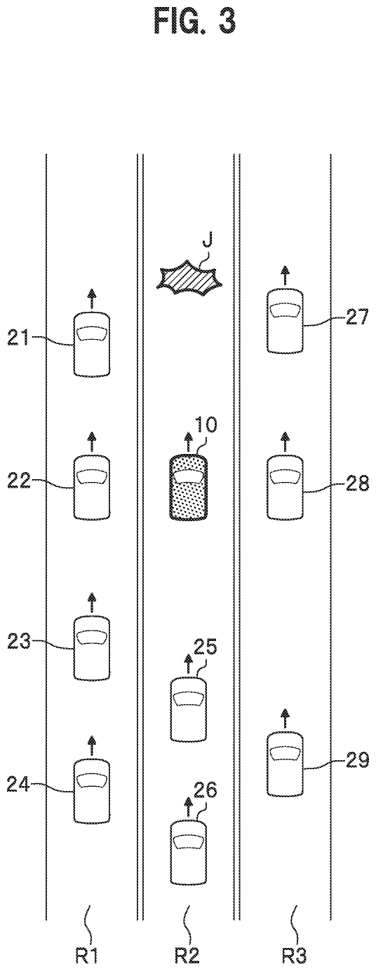

In addition, the possible event can occur depending on how other vehicles move, when the vehicle 10 changes lanes or driving control is performed on a merging lane. In order to explain the first embodiment below, plural “action plans” to be taken when there is a possible object J (See FIG. 3) frontward of the vehicle 10 (driver's vehicle) are described as an example and each of the sections of the autonomous driving control part 162 is described as well.

FIG. 3 illustrates an example of a circumstance where a possible event occurs involving the vehicle 10 that is running.

FIG. 3 shows schematically three lanes R1, R2, R3 that are viewed from above and skips oncoming lanes. In addition, FIG. 3 shows a circumstance where there is a possible object J (wrong direction running vehicle, person, a fallen rock or the like) present ahead of the vehicle 10 (driver's vehicle) that is running on a middle lane R2.

When the vehicle 10 encounters the circumstance as shown in FIG. 3 while the vehicle 10 is autonomously running, the vehicle 10 should change lanes to a right or left side lane to prevent colliding with the object J.

However, there is another vehicle 28 running on the right side of the vehicle 10 with a vehicle 27 running relatively short distance away from and ahead of the vehicle 28 in the example of FIG. 3. Furthermore, the same is true of the left side lane R1. Then, in order to prevent the vehicle 10 from colliding with the frontward object J, the control device 16 (See FIG. 2) prepares plural plans for the vehicle 10 to collaborate with other vehicles and select and perform an appropriate plan of them.

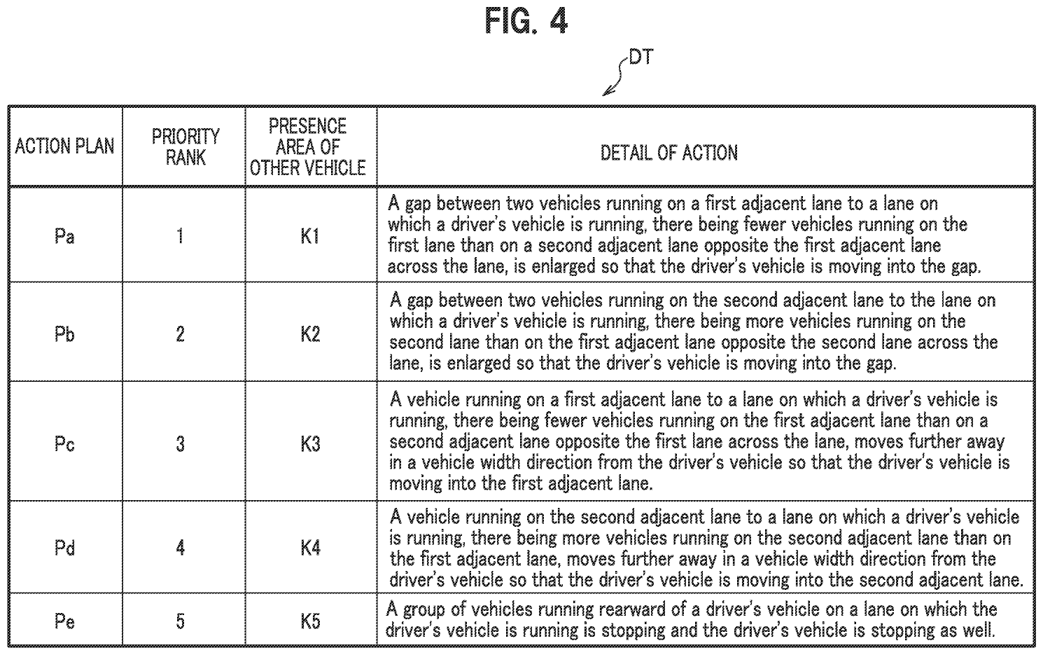

The action plan preparing section 162a as shown in FIG. 2 has a function of preparing plural action plans associated with the possible event as described. These action plans are explained with reference to FIG. 4.

FIG. 4 describes a table DT listing five action plans Pa˜Pe that can be taken when an event occurs that there is an object ahead of the vehicle 10.

An action plan Pa is intended to have a vehicle-to-vehicle gap enlarged when the vehicle 10 is moving into a lane where the number of vehicles is smaller. The “number of vehicles” is the number of other vehicles that are present within an area extending a predetermined distance frontward and located rearward of the vehicle 10 in any of the lanes R1, R2, R3 (See FIG. 3).

“Having a vehicle-to-vehicle gap enlarged” means that having other vehicles running on a lane into which the vehicle 10 is moving make a vehicle-to-vehicle gap between them larger so that the vehicle 10 can move into their vehicle-to-vehicle gap. For instance, if the vehicle 10 is moving into the lane R3 on the right side of the vehicle 10, a vehicle-to-vehicle gap between another vehicle 27 running diagonally frontward of the vehicle 10 and another vehicle 28 running on the right side of the vehicle 10 is made so much larger that the vehicle 10 can move into the vehicle-to-vehicle gap by having the vehicle 27 accelerate and having the vehicle 28 decelerate.

This action plan Pa enables the vehicle 10 to avoid colliding with the object ahead, and an influence on the other vehicles (especially influence of accelerations on passengers) is relatively small. As a result, a first priority rank is given to the action plan Pa.

An action plan Pb as indicated in FIG. 4 is to have a vehicle-to-vehicle gap enlarged by other vehicles running on a lane where the number of vehicles is relatively large when the vehicle 10 is moving into the lane. In the case of the example as shown in FIG. 3, the number of vehicles is larger on the lane R1 located on the left side of the vehicle 10 (driver's vehicle) than on the lane R3 located on the right side of the vehicle 10. As a result, the influence of having the vehicle-to-vehicle gap enlarged on the other vehicles (especially influence of an acceleration to applied to passengers) is larger. On the other hand, if the vehicle 10 can manage to perform the action plan Pb, the vehicle advantageously can avoid colliding with the object J ahead. As result, a second priority rank is given to the action plan Pb.

If there is a problem with the vehicle 10 communicating with other vehicles running near the vehicle 10, the action plan Pa to which the first priority rank is given cannot be necessarily performed by the control device 16. In addition, the state around the vehicle 10 changes from moment to moment. Then, in case the action plan Pa to which the first priority rank is given cannot be performed due to the state around the vehicle 10 or the communication problem, the control device 16 determines whether the action plans Pb˜Pe to which second and lower priority ranks are given can be performed in a sequential order of the priority ranks The rest of the action plans Pc˜Pe are described later.

In addition, the number of events is not limited to one. For each of plural events that can be predicted to occur, plural action plans may be prepared. In addition, the action plans for the event when the object J is present ahead are not limited to those listed in FIG. 4.

The action plan preparing section 162a prepares plural action plans associated with a possible event. Data on these action plans are stored as pieces of action plan information 161b in the storage part 161. The communication section 162b is a communication interface that can receive data from and send data to the V2X communication device 14. The communication section 162b has not only a function of performing vehicle-to-vehicle communication with other vehicles, but also a function of performing vehicle-to-road communication with a predetermined roadside device H (See FIG. 1).

The event detection device 162c may detect a possible event that can have an influence on the vehicle 10 running. For example, the event detection section 162c can recognize that the vehicle 10 is approaching the object J based on the information inputted from the external world sensor 11 and then detects the vehicle 10 approaching the object J as a possible event. Additionally, when the event detection section 162c receives a piece of predetermined information (on such an event as requires an emergency avoidance action by the vehicle 10) from another vehicle through the V2X communication device 14 or the communication section 162b, the event detection section 162c may detect this event as a possible event.

Furthermore, the event detection section 162c may determine whether the event that can influence the vehicle 10 running requires that the vehicle 10 (for instance, a wrong direction running vehicle is approaching) perform an emergency avoidance action or not.

The area determining section 162d determines a presence area in which there are other vehicles with which the vehicle 10 has to communicate for each of the plural action plans associated with the possible event.

For instance, in the case of the action plan Pa as indicated in FIG. 4, the presence area in which other vehicles with which the vehicle 10 has to collaborate for the action plan Pa are present (identification information on other vehicles) is determined based on relative positions of the other vehicles to the vehicle 10 and vehicle-to-vehicle distances between the other vehicles.

The evaluation section 162e as shown in FIG. 2 evaluates a state of communication between the vehicle 10 (driver's vehicle) and the other vehicles that are present within the presence area determined by the area determining section 162d. For example, the evaluation section 162e evaluates the state of communication with each of the plural other vehicles that are present within the presence area based on a time from when the vehicle 10 sends a connection request to when the vehicle 10 receives an acknowledge signal from the other vehicle and a noise included in the received signal.

There may be a case in which there is a vehicle of the plural other vehicles that does not send back an acknowledge signal (positive response) to the vehicle 10 after the vehicle 10 sends a predetermined connection request signal. In this case, the evaluation section 162e determines that the communication with this vehicle that does not send back the acknowledge signal is impossible. An example of this kind of the vehicle is a vehicle that is not equipped with the V2X communication device.

When there is a vehicle that is unable to communicate with the vehicle 10 near the vehicle 10, the position of this vehicle is determined with the following method. That is, the control device 16 can determine the position of another vehicle based on information from the external world sensor 11 of the vehicle 10 or possibly based on information from either of another vehicle and the roadside device H which are able to communicate with the vehicle 10 and have taken an image of the vehicle that is unable to communicate with the vehicle 10.

The action plan selecting section 162f selects an action plan to be performed from among the plural action plans based on the evaluation results prepared by the evaluation section 162e. Procedures by the action plan selecting section 162f are described later.

The running control section 162g performs the action plan selected by the action plan selecting section 162f. That is, the running control section 162g controls the vehicle 10 to run in accordance with a predetermined instruction based on the detection results of the external world sensor 11 and the driver's vehicle state sensor 12, information from the V2X communication device 14 and the like. The control operation as mentioned above includes controlling the driving power generating device 17, the steering operation device 18 and the braking operation device 19.

The driving power generating device 17 differ between the vehicle types (electric vehicle, hybrid vehicle, fuel cell vehicle, gasoline engine vehicle, diesel engine vehicle), but the structure of each driving power generating device 17 is well known and its explanation is skipped. In addition, explanation on the steering operation device 18 to steer a vehicle and the braking operation device 19 to decelerate the vehicle is skipped as well.

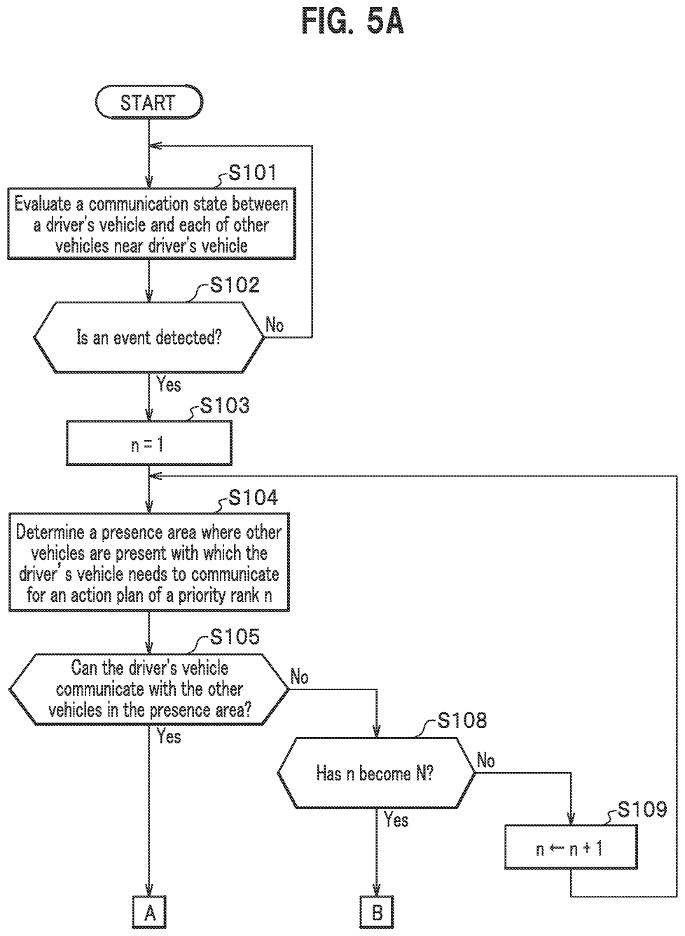

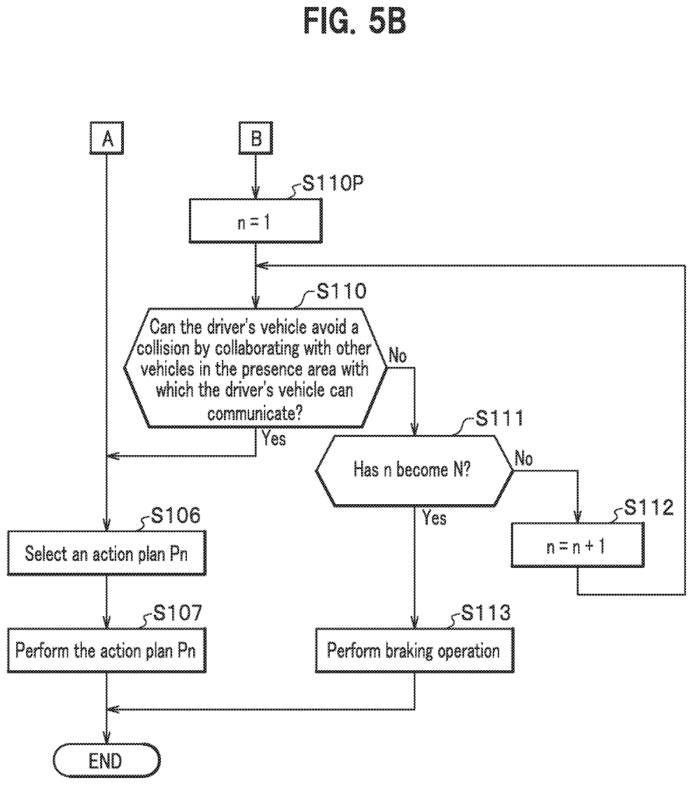

FIG. 5A is a flow chart of a control procedure to be performed by the control device 16 of the first embodiment (See FIG. 2A where appropriate).

The vehicle 10 is assumed to be running at a time of “START” in this flow chart. The communication section 162b of the control device 16 continually repeats a procedure to establish communication with other vehicles through the V2X communication device 14 (communication step), which is not included in this flow chart.

In Step S101, the control device 16 has the evaluation section 162b evaluate how well the vehicle 10 can communicate with other vehicles located close to the vehicle 10 (driver's vehicle). The control device 16 as shown in FIG. 3 evaluates how well the vehicle 10 can communicate with each of the other vehicles 21˜29 running near the vehicle 10.

In Step S102, the control device 16 determines whether the control device 16 has detected that a possible event has occurred or not (event detection step). If no possible event is detected in Step S102 (No in Step S102), the control procedure by the control device 16 returns to Step S101.

On the other hand, if a possible event is detected in Step S102 (Yes in Step S102), the control procedure by the control device 16 proceeds to Step S103. For instance, when the control device 16 has detected an object J (See FIG. 3) coming closer to the driver's vehicle, it determines that the possible event has occurred (Yes in Step S102).

When the control device 16 determines that the possible event has occurred (Yes in Step S102), the control device 16 may have the event detection section 162e further determine whether the detected event requires that the vehicle 10 perform an emergency avoidance action. Then, the control device 16 may proceed to Step S103 if the event that is detected requires that the vehicle 10 perform an emergency avoidance action.

In Step S103, the control device 16 sets n to 1 (n=1). Here, the value n corresponds to a priority rank of an action plan of the plural action plans Pa˜Pe (See FIG. 4) and is incremented in Step S109 to be described later when needed. In Step S103, the value n is set to 1 to start with determining whether the action plan Pa (See FIG. 4) to which the first priority rank is given can be performed in the subsequent process. In Step S104, the control device 16 has the area determining section 162d determine a presence area where other vehicles are present, with which the control device 16 needs to communicate to perform an action plan of the priority rank of n (Area determining step). For instance, when the value n is set to n=1 (Step S103), the control device 16 has the area determining section 162d determine the presence area where other vehicles are present, with which the control device 16 needs to communicate to perform the action plan Pa (See FIG. 4) of the first priority rank (Step S104).

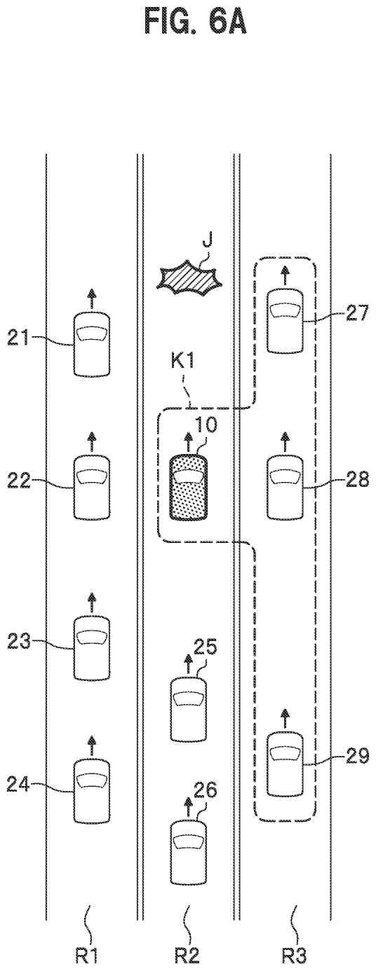

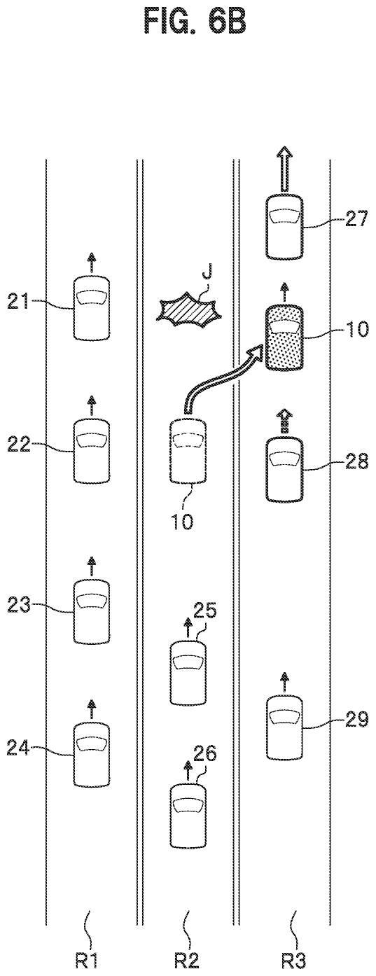

FIG. 6A shows a presence area K1 where other vehicles are present, with which the control device 16 has to communicate for the action plan Pa.

In the presence area K1, there are vehicles with which the vehicle 10 (driver's vehicle) needs to communicate for the action plan Pa (See FIG. 6B as well) in which the vehicle 10 is moving rightward into the adjacent lane R3. The communication states between each of these vehicles and the vehicle 10 are evaluated and these vehicles that are present in the presence area K1 are as follows. That is, other vehicles 27 to 29, with which the vehicles 10 needs to collaborate to change lanes according to the action plan Pa, are included in the presence area K1.

In Step S105 as shown in FIG. 5A, the control device 16 has the evaluation section 162b determine whether communication between the vehicle 10 and the other vehicles in the above-mentioned area is established or not (evaluation step). If the communication with all other vehicles in the predetermined area is established (Yes in Step S105), the control procedure by the control device 16 proceeds to Step S106 in FIG. 5B. In the case of an example as shown in FIG. 6A, the control procedure by the control device 16 proceeds to Step S106 in FIG. 5B if the communication with all of the other vehicles 27 to 29 included in the presence area K1 is established.

In Step S106, the control device 16 has the action plan selecting section 162f select an action plan Pn to be performed (Action plan selecting step). Thus, the control device 16 selects from among the plural action plans Pa˜Pe an action plan Pn to be performed for which the communication between the vehicle 10 and all vehicles within a corresponding presence area (for example, area K1 in FIG. 6A) is established. As a result, the selected action plan Pn can be performed by the vehicle 10 collaborating with the other vehicles with which the communication is established.

In Step S107, the control device 16 has the running control section 162g perform the action plan Pn.

FIG. 6B illustrates how the action plan Pa is performed.

In the case of an example as shown in FIG. 6B, the control device 16 of the vehicle 10 (driver's vehicle) performs the action plan Pa after the possible event that there is an object J ahead of the vehicle 10 is detected. To be specific, when the vehicle 10 is moving into the lane R3 on the right side of the vehicle 10, the communication section 162b requests that the vehicle 27 accelerate and that the vehicle 28 decelerate, in order to make a gap between the other vehicles 27, 28 so much larger that the vehicle 10 can move into the gap. In accordance with this request, the vehicle 27 accelerates while the vehicle 28 that is different from the vehicle 27 decelerates, and thus the gap between the vehicles 27, 28 is made so much larger that the vehicle 10 can move into the gap. As a result, the vehicle 10 can avoid collision with the object J by moving into the gap between the vehicles 27, 28.

When the communication section 162b requests the vehicles 27 to 29 to accelerate or decelerate, the communication section 162b preferably further requests the vehicles 27 to 29 to temporarily stop an operation mode in which these vehicles are autonomously running to avoid coming into contact with an object. According to this operation mode, another vehicle that is autonomously running to accelerate, decelerate, and turn on its own to avoid coming into contact with an object when a distance from another vehicle to the object becomes equal to or smaller than a predetermined distance. If the vehicles 27 to 29 temporarily stop this operation mode, for instance, there is hardly a risk that the vehicle 28 makes a sudden deceleration or a sudden turn to avoid coming closer to the vehicle 10 even if the vehicle 10 is temporarily located closer to the vehicle 28.

Accordingly, the vehicle 10 can smoothly change lanes even when there is an emergency event occurring such as a wrong direction running vehicle (object J) coming closer to the vehicle 10 from frontward.

In addition, when the event detection section 162c detects that there is a possible event that requires an emergency avoidance action, the communication section 162b may notify other vehicles of the possible event occurring. This notification may be, so called, performed by broadcasting. Thus, the emergency event occurring is notified to, for example, the vehicles 25, 26 running rearward of the vehicle 10 (See FIG. 6A). As a result, the vehicles 25, 26 can take an appropriate action in response to the event. In addition, the other vehicles running on any of the lanes R1 and R3 (for example, another vehicle 24) that receive the notification can refrain from moving into the lane R2.

The control procedure is described again with reference to FIG. 5A.

In Step S105, the control procedure by the control device 16 proceeds to Step S108 if there is another vehicle, with which it is difficult for the vehicle 10 to communicate, of the plural other vehicles within the predetermined presence area (No in Step S105).

In Step S108, the control device 16 determines whether the value n becomes a value N. The value N is a total number of the plural action plans Pa˜Pe associated with a possible event (N=5 in the case of the example in FIG. 4). In Step S108, if the value n is smaller than the value N (No in Step S108), the control procedure by the control device 16 proceeds to Step S109. Thus, the evaluation section 162e of the control device 16 evaluate the communication states for the plural action plans Pa starting with the action plan Pa given the first (highest) priority rank and then evaluates the communication states for the action plans Pb˜Pe (See FIG. 4) in the sequential order of the priority ranks given to the plural action plans from the highest priority rank toward the lowest priority rank.

In Step S109, the control device 16 increments the value n by 1 (n=n+1). For instance, when the value n is set to 1, the control device 16 increments the value n to n=2 in Step S109. After Step S109 is finished, the control procedure by the control device 16 returns to Step S104. Then, the control device 16 performs the predetermined processes on the action plan Pb of the second priority rank (See FIG. 4) (Step S104, Step S105).

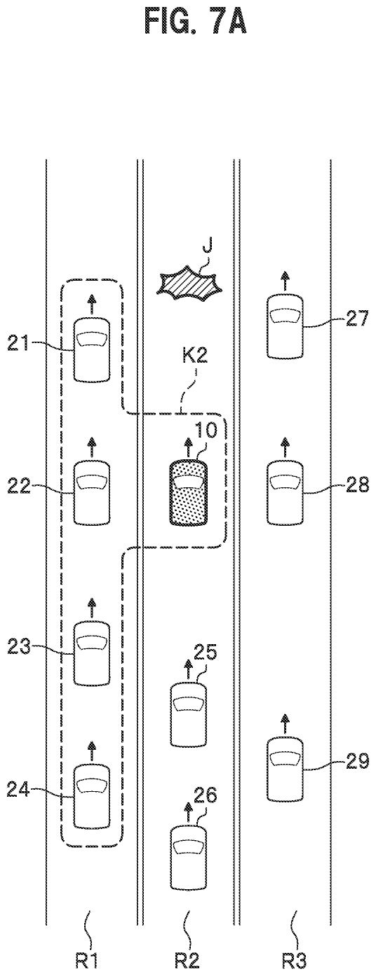

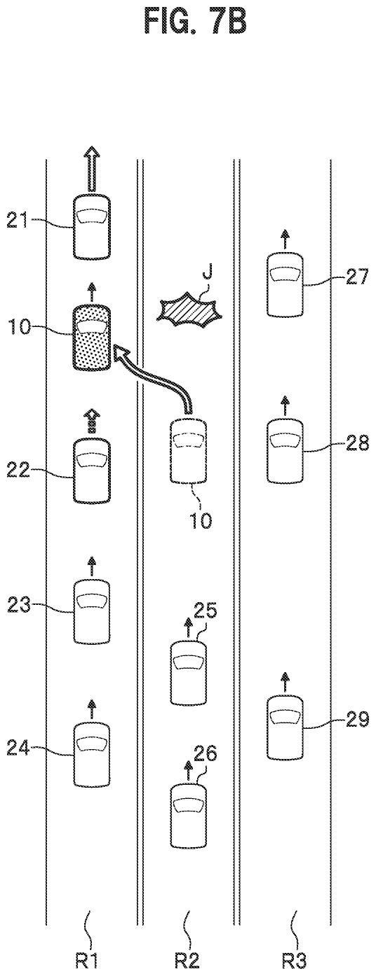

FIG. 7A shows a presence area K2 where other vehicles are present, with which the control device 16 has to communicate for an action plan Pb. The presence area K2 as shown in FIG. 7A indicates an area where other vehicles are present, communication states with which are evaluated for the action plan Pb in which the vehicle 10 (driver's vehicle) is moving into the left lane R1. There are other vehicles 21 to 24 running on the left lane R1, which are present in the presence area K2.

FIG. 7B illustrates how the action plan Pb is performed. In the case of an example illustrated in FIG. 7B, the communication section 162b requests that the vehicle 21 running diagonally frontward of the vehicle 10 accelerate and that vehicle 22 running rearward of the vehicle 21 decelerate, in order to have a gap between the vehicles 21, 22 enlarged so that the vehicle 10 is moving into the gap for the action plan Pb. Thus, the vehicle 10 can avoid colliding with the object J by moving into the gap between the vehicles 21, 22.

Next, the remaining three action plans Pc˜Pe (given third˜fifth priority ranks, See FIG. 4) are briefly explained.

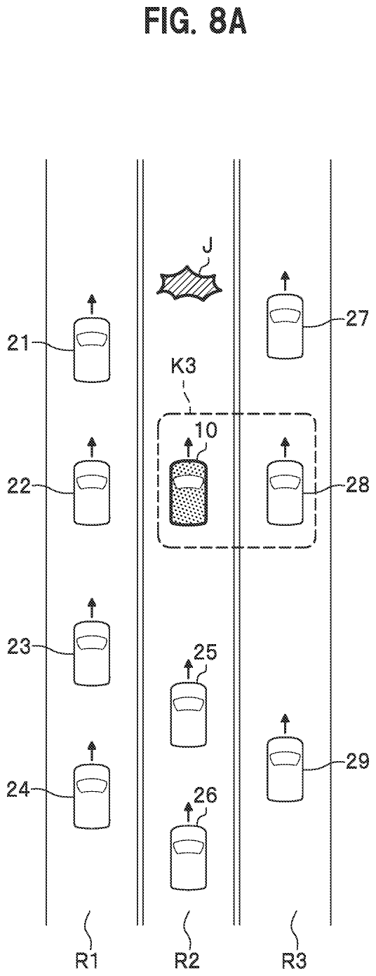

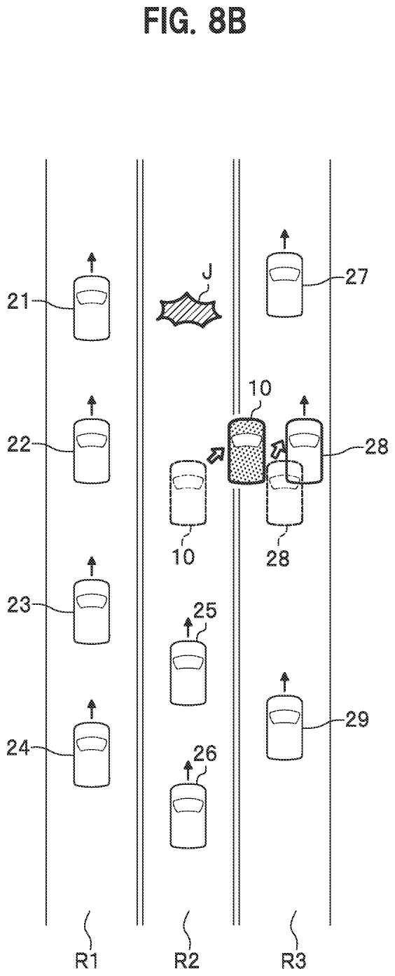

FIG. 8A shows a presence area K3 where another vehicle is present, with which the control device 16 has to communicate for the action plan Pc.

The presence area K3 for the action plan Pc includes another vehicle 28 on the right-side lane R3 (See FIG. 8B as well). The vehicle 10 is temporarily running side by side with the vehicle 28. The communication state between the vehicle 10 and the vehicle 28 is evaluated. Accordingly, the communication of the vehicle needs to be established advantageously with fewer vehicles for the action plan Pc.

FIG. 8B illustrates how the action plan Pb is performed.

In the case of an example as illustrated in FIG. 8B, when the vehicle 10 (driver's vehicle) is moving rightward into the adjacent lane R3 after a possible event is detected, the communication section 162b requests that the vehicle 28 running side by side in the vehicle width direction with vehicle 10 move further away in the vehicle width direction from the vehicle 10. After this request is sent out, the vehicle 10 is temporarily running side by side with the vehicle 28 on the adjacent right-side lane R3. As a result, the vehicle 10 can avoid colliding with the object J.

The action plan Pd of the fourth priority rank (See FIG. 4) is the same as the action plan Pc (See FIG. 8A and FIG. 8B) except that the vehicle 10 is moving leftward into the adjacent lane R1 where there are more vehicles running. Thus, a detailed explanation on the action plan Pd is skipped.

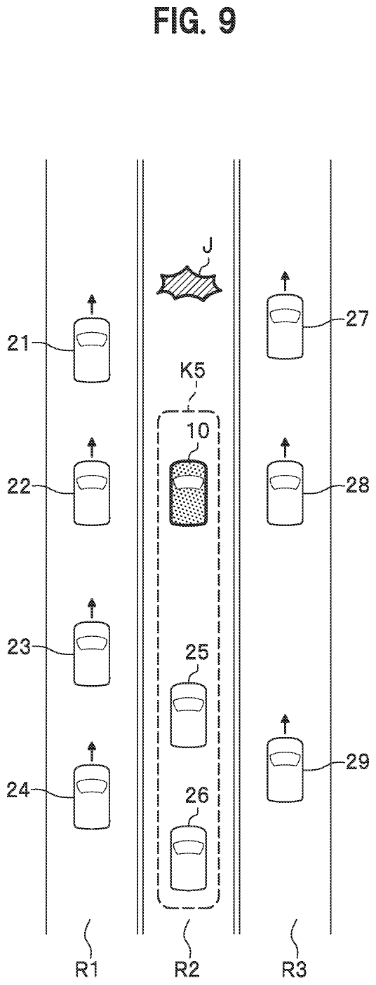

FIG. 9 shows a presence area K5 where other vehicles are present, with which the control device 16 has to communicate for the action plan Pe.

According to the action plan Pe, the control device 16 requests that both the other vehicles 25, 26 running rearward of the vehicle 10 on the lane R2 on which the vehicle 10 is running stop after the possible event is detected and the vehicle 10 is stopping on the lane R2 as well. As a result, the vehicle 10 can avoid (or reduce a damage from) colliding with the object J. In addition, there is hardly a risk that the vehicle 10 is hit by the vehicle 25 running from rearward. It should be noted that there is a sufficiently large gap between the vehicle 26 located most rearward within the presence area K5 and another vehicle (not shown) running rearward of the vehicle 26.

In Step S108 in FIG. 5A, if the value n has already become the value N (Yes in Step S108), the control procedure by control device 16 proceeds to Step 110P in FIG. 5B. That is, if there is any vehicle with which it is difficult for the vehicle 10 to communicate in the presence area determined for every action plan of the action plans Pa˜Pe, the value n becomes the value N in Step S108 and the control procedure by the control device 16 proceeds to Step S110P in FIG. 5B.

In Step 110P in FIG. 5B, the value n is set back to n=1.

Then, in Step S110 in FIG. 5B, the control device 16 determines whether the vehicle 10 can manage to avoid colliding with the object ahead by collaborating with those vehicles in the presence area for the action plan Pn with for the value n, with which the vehicle 10 can communicate, those vehicles being other than one in the presence area with which it is difficult for the vehicle 10 to communicate. If the vehicle 10 can manage to avoid the collision by collaborating with those vehicles in the presence area for the action plan Pn, with which the vehicle 10 can communicate (Yes in Step S110), the control device 16 selects the action plan Pn (Pa for n=1, Step S106) and performs the action plan Pn (Step S107).

To specifically describe the control procedure, it is assumed in FIG. 6A that it is difficult for the vehicle 10 (driver's vehicle) to communicate, for example, with another vehicle 27 of the other vehicles 27 to 29 within the presence area K1, the vehicle 27 being located diagonally frontward of the vehicle 10. In this case, if the vehicle 28 running just on the right side of the vehicle 10 decelerates, it is possible to enlarge a gap between the vehicles 27, 28 so that the vehicle 10 can come into the gap. In order to do this for the action plan Pa, the communication section 162b of the control device 16 requests that the vehicle 28 decelerate. As a result, the vehicle 10 can avoid colliding with the object J even when there is another vehicle 27 near the vehicle 10 with which it is difficult for the vehicle 10 to communicate.

If the vehicle 10 cannot avoid colliding with the object J by collaborating with the vehicles in the presence area with which communication is established (No in Step S110), the control procedure by the control device 16 proceeds to Step S111.

In Step S111, the control device 16 determines whether the value n has become the value N. As has been described, the value N corresponds to the total number of the action plans Pa˜Pe (N=5 in the case of the example as shown in FIG. 4). If the value n is smaller than the value N in Step S111 (No in step S111), the control procedure by the control device 16 proceeds to Step S112.

In Step S112, the control device 16 increments the value n by 1 and goes back to Step S110 to perform the determination process in Step S110 again for the action plan corresponding to the current n value. On the other hand, if the value n has already become the value N in Step S111 (Yes in Step S111), the control procedure by the control device 16 proceeds to Step S113.

The control device 16 performs a predetermined braking operation. By performing this operation, the influence that the possible event has on the vehicle 10 can be reduced. After Step S113 is performed, the control device 16 ends a series of the operations (END).

Next, other kinds of events are briefly explained.

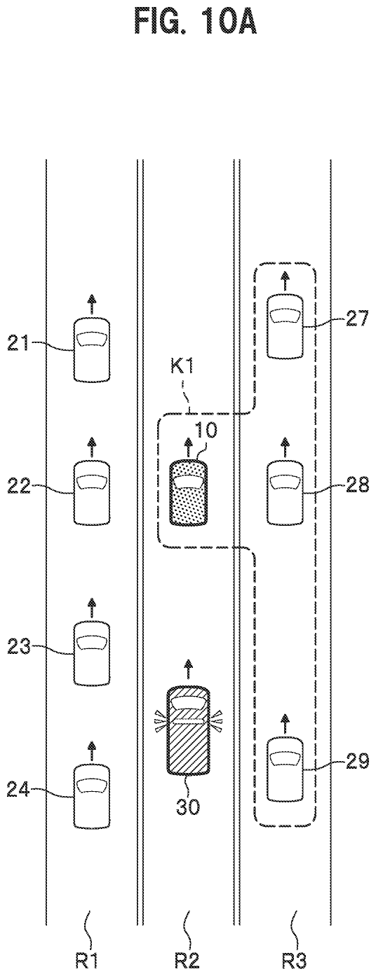

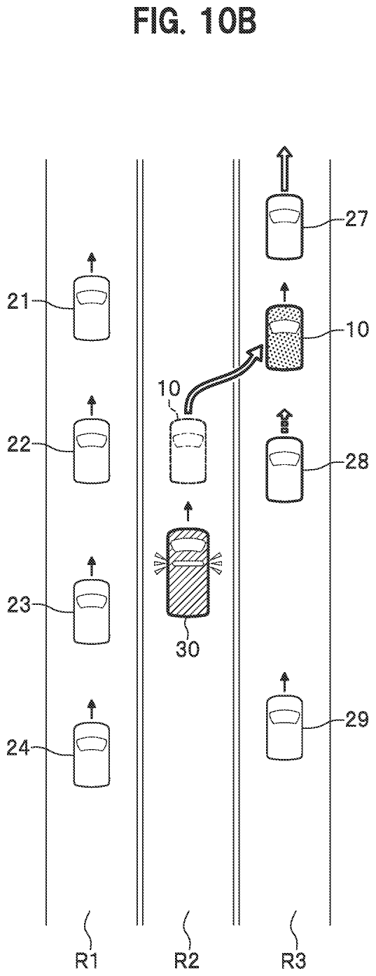

FIG. 10A shows a presence area K1 where other vehicles are present with which the vehicle 10 has to communicate for a predetermined action plan when an emergency vehicle 30 is approaching the vehicle 10 from rearward of the vehicle 10.

In a situation as shown in FIG. 10A, the event detection section 162c (See FIG. 2) detects the emergency vehicle 30 (fire-fighting vehicle, ambulance, police vehicle or the like) that is running on the lane R2 on which the vehicle 10 (driver's vehicle) is running and approaching the vehicle 10 from rearward of the vehicle 10. This detection may be made through a predetermined signal emitted by the emergency vehicle 30 or based on a detection result of the external world sensor 11 (See FIG. 2). Thus, the event detection section 162c (See FIG. 2) may have a function of determining whether or not the possible event is the emergency vehicle 30 approaching the vehicle 10 as well.

When the emergency vehicle 30 approaching the vehicle 10 is detected, the control device 16 may perform a predetermined action plan (See FIG. 10B as well) to move to the right-side lane R3 to have the emergency vehicle 30 preferentially run on the lane R2. When this action plan is performed, the control device 16 may have the evaluation section 162e evaluate communication states with the other vehicles with which the vehicle 10 has to collaborate. Then, if the communication is established with the other vehicles 27˜29, the control device requests that the vehicle 27 accelerate and that the vehicle 28 decelerate, in order to enlarge a gap between the vehicles 27, 28 so that the vehicle 10 is able to move into the gap (See FIG. 10B as well).

FIG. 10B illustrates how the predetermined action plan is performed when the emergency vehicle is approaching the vehicle 10 from rearward of the vehicle 10.

The vehicle 10 moves into the gap between the vehicles 27, 28 after the requests by the control device 16 and the emergency vehicle 30 is easily running on the lane R2. Similar action plans to the action plans Pb, Pc, Pd in FIG. 4, which are different from the action plan for the vehicle 10 to move to the right-side lane (Same as the action plan Pa in FIG. 4), may be given predetermined priority ranks and put in the action plan list in advance.

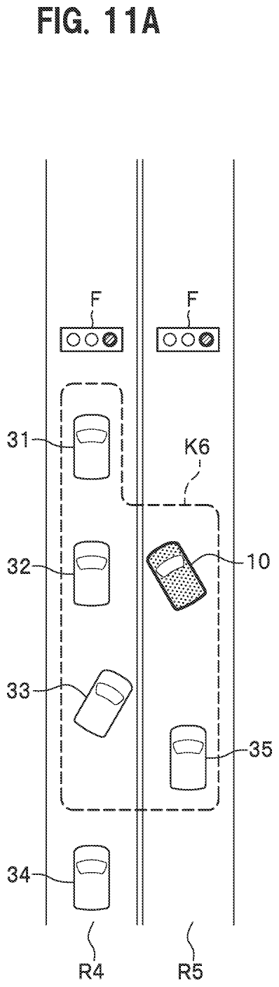

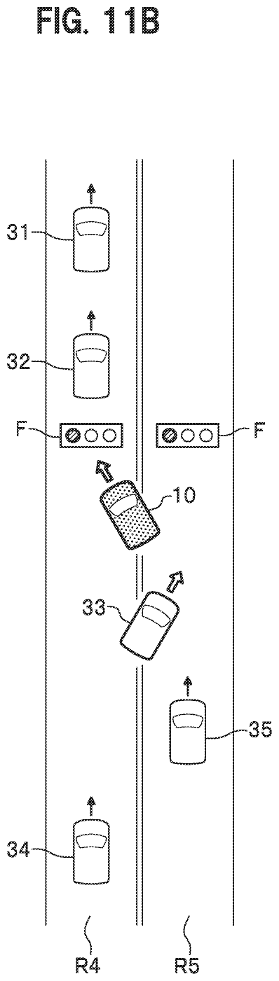

FIG. 11A shows a different example of a circumstance where a different possible event occurs while the vehicle 10 is running (See FIG. 2 when necessary). FIG. 11A schematically shows lanes R4, R5 that are viewed from above. In the case of the example in FIG. 11A, since a traffic light F shows a red light for a stop, other vehicles 31˜34 are in line in this order on the left side lane R4 and at a stop short of the traffic light. In this case, the vehicle 33 is at a stop being oriented in a direction from the left side lane R4 diagonally toward the right-side lane R5. On the other hand, the vehicle 10 (driver's vehicle) is moving from the right-side lane R5 to a gap between the other vehicles 31, 32 on the left-side lane R4.

The control device 16 of the vehicle 10 (See FIG. 2) may determine whether the vehicle 33 is changing lanes based on a signal inputted from the external world sensor 11 or a signal received from another vehicle 33. A predetermined circumstance that occurs when the vehicle 10 is changing lanes (the vehicle 33 is changing lanes as well in the case shown in FIG. 11A) may be a possible event for the predetermined action plans.

The control device 16 (See FIG. 2) may determine a presence area (area K6 in FIG. 11A) where other vehicles with which the vehicle 10 has to communicate are present for each of the plural action plans (not shown) associated with the event. In addition, the control device 16 may perform the action plan based on communication states with the other vehicles 31, 32, 33, 35 that are included in the predetermined area K6. In the example as shown in FIG. 11A, there is a space left rearward of the vehicle 32 after the vehicle 33 changes lanes. Therefore, the vehicle 10 performs, for example, an action plan to move into the space left rearward of the vehicle 32 after the vehicle 32 moves.

FIG. 11B illustrates how a predetermined action plan is performed.

As illustrated in FIG. 11B, the control device 16 can perform the predetermined action plan to have the vehicle 10 move from the lane R5 to the space rearward of the vehicle 32 in the lane R4 after waiting for the vehicle 32 to move. If the vehicle 10 performs this action plan, the vehicle 10 can change lanes more smoothly than moving into a gap between the vehicles 31, 32.

<Action/Effect of the First Embodiment>

The control device of the vehicle of the first embodiment has a configuration as described above. Next, actions and effects of this control device are explained.

As shown in FIG. 1˜FIG. 4, the control device 16 (movable object control device) comprises a processor including an event detection section 162c detecting an occurrence of a possible event that influences the vehicle 10 (movable object of interest) running that is equipped with a communication section 162b through which the vehicle 10 communicates with other vehicles (other movable objects), an area determining section 162d determining a presence area where the other vehicles are present with which the vehicle 10 has to communicate for each of plural action plans associated with the possible event detected by the event detection section 162c, an evaluation section 162e evaluating communication states between the vehicle 10 (driver's vehicle) and the other vehicles within the presence area, and an action plan selecting section 162f selecting an action plan to be performed from among the plural action plans based on an evaluation result received from the evaluation section 162e.

According to this configuration, an appropriate action plan is selected from among the plural action plans based on the evaluation result on the communication states with the other vehicles, when a possible event occurring is detected. As a result, the control device 16 can manage to take an appropriate action for a circumstance which it is difficult that the vehicle 10 (driver's vehicle) can cope with on its own by collaborating with the other vehicles.

In addition, the area determining section 162d preferably determines the presence area based on a predetermined table DT in which the presence area where other vehicles are present with which the vehicle 10 has to communicate for each of the plural action plans, as shown in FIG. 2 and FIG. 4.

According to this configuration, the control device 16 can appropriately determine the presence area where other vehicles are present with which communication is needed to be established based on the predetermined table DT.

In addition, the event detection section 162c determines whether the possible event requires an emergency avoidance action to be performed by the vehicle 10 (movable object of interest). If the event detection section 162c determines that the possible event requires the emergency avoidance action to be performed by the vehicle 10, the action plan selecting section 162f preferably selects from among the plural action plans an action plan to be performed for which the communication between the vehicle 10 and all of the other vehicles (other movable objects) that are present in the presence area is established.

According to this configuration, the action plan of the plural action plans, for which communication is established with all of the other vehicles in the presence area, is performed. That is, there is no other vehicle in the presence area with which it is difficult for the vehicle 10 to communicate. As a result, the control device 16 can manage to appropriately cope with a possible event that requires an emergency action.

The event detection section 162c preferably notifies the other vehicles (other movable objects) near the vehicles 10 of the possible event occurring through the communication section 162b, if the event detection section 162c determines that the possible event requires an emergency avoidance action to be performed by the vehicle 10 (movable object of interest).

According to this configuration, the other vehicles are notified of the possible event occurring and can manage to take an action for the possible event.

The plural action plans preferably includes an action plan as illustrated in FIG. 4, FIG. 6A, FIG. 6B, FIG. 7A and FIG. 7B, in which the vehicle 10 (movable object of interest) moves into a space made between two other vehicles (other movable objects) running on an adjacent lane after the vehicle 10 requests these other vehicles to accelerate or decelerate through the communication section 162b when the vehicle 10 is changing lanes into the adjacent lane after the possible event is detected.

According to this configuration, the vehicle 10 can change lanes to the adjacent lane to avoid colliding with the object J ahead, when there occurs a possible event.

In addition, when the communication section 162b requests the other vehicles (other movable objects) running on the adjacent lane to accelerate or decelerate, the communication section 162b preferably requests the other vehicles to temporarily stop an operation mode to autonomously run to avoid coming in contact with an object as well.

According to this configuration, the vehicle 10 can smoothly change lanes if the vehicle temporarily comes close to another vehicle when the vehicle 10 is moving into the adjacent lane.

As shown in FIG. 5A and FIG. 5b, when there is a first vehicle (first movable object) in the presence area for an action plan with which it is difficult for the vehicle 10 (movable object of interest) to communicate and this first vehicle is running in an immediate vicinity or diagonally ahead on the adjacent lane, the communication section 162b preferably requests a second vehicle (second movable object) running rearward of the first vehicle to decelerate for the action plan to be performed if communication is established between the vehicle 10 and this second vehicle.

According to this configuration, even if there is a first vehicle in the presence area with which it is difficult for the vehicle 10 (driver's vehicle) to communicate, the vehicle 10 can move into a space made by a second vehicle decelerating, with which communication is established, after the vehicle 10 requests the second vehicle to decelerate.

In addition, the plural action plans preferably includes an action plan as illustrated in FIG. 4, FIG. 8A and FIG. 8b, in which the communication section 162b requests that another vehicle (another movable object), which is running on the adjacent lane and side by side in the vehicle width direction with the vehicle 10, move further away in the vehicle width direction from the vehicle 10 within the adjacent lane and subsequently the vehicle 10 is at least temporarily running side by side with the other vehicle in the adjacent lane.

According to this configuration, the control device 16 performs an action plan in which the vehicle 10 moves into the adjacent lane and at least temporarily runs side by side with another vehicle and can manage to avoid the vehicle 10 colliding with the object J.

In this action plan, there is only a vehicle with which the vehicle 10 has to communicate and thus it is rather easy to perform this action plan.

In addition, the plural action plans preferably includes an action plan as illustrated in FIG. 4 and FIG. 9, in which the control device 16 has the communication section 162b request at least one of the other vehicles (other movable objects) running rearward of the vehicle 10 on the same lane as the vehicle 10 is running to stop or decelerate after the possible event is detected.

According to this configuration, the vehicle 10 and another vehicle running on the same lane as the vehicle 10 stop or decelerate on the lane on which the vehicle 10 (driver's vehicle) is running. As a result, the influence (such as collision with the object J) by the possible event is reduced.

As indicated in FIG. 4, it is preferable that each of the plural action plans is given a priority rank and that the evaluation section 162e evaluates the communication states for the plural action plans according to the sequential order of the priority ranks from the highest priority rank toward the lowest priority rank.

According to this configuration, the communication states with other vehicles are evaluated in accordance with the priority ranks of the plural action plans and the action plan selecting section 162f can select an action plan that can be performed and has a relatively high priority rank based on the evaluation results.

In addition, the action plan selecting section 162f preferably selects an action plan to be performed based on the evaluation result by the evaluation section 162e when the event detection section 162c detects a possible event of an emergency vehicle 30 approaching the vehicle 10, as illustrated in FIG. 10A and FIG. 10B.

According to this configuration, the control device 16 of the vehicle 10 can perform a predetermined action plan to have an emergency vehicle 30 such as a fire-fighting vehicle, an ambulance or police vehicle easily run through.

### Second Embodiment

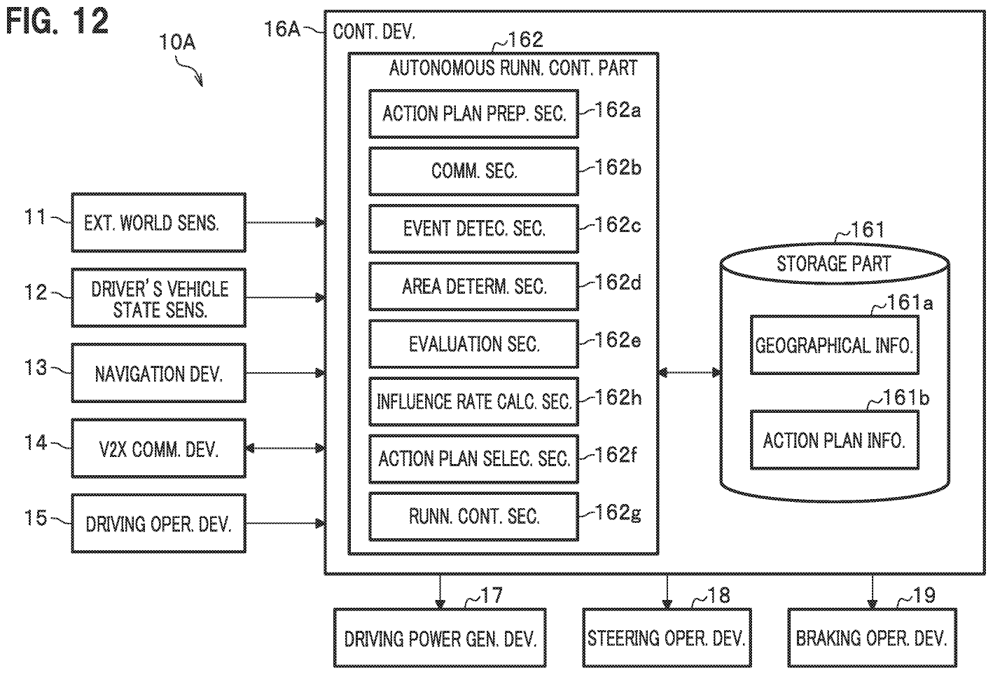

A control device 16A of the second embodiment (See FIG. 12) further comprises an influence rate calculation section 162h, which is not included in the first embodiment. In addition, the second embodiment differs from the first embodiment in that the action plan is selected based on the influence rate calculated by the influence rate calculation section 162h (See FIG. 12). The other configuration than this is the same as the first embodiment. Hereinafter, a different configuration of the second embodiment from the first embodiment is explained and the same configuration is not explained again

FIG. 12 is a functional block diagram including a control device 16A of a second embodiment.

As shown in FIG. 12, the control device 16A comprises an influence rate calculation section 162h in addition to the elements described for the first embodiment (See FIG. 2).

The influence rate calculation section 162h may calculate for each of the plural action an influence rate of each plans on each of the vehicle 10 and the other vehicles that are present in the presence area (for example, presence area K1 in FIG. 6A) if the action plan is performed. The influence rate is a value indicative of how large an influence a predetermined action plan has on each of the vehicle 10 and the other vehicles if the predetermined action plan is performed.

For instance, the influence rate calculation section 162h has such a calculation function that the higher an absolute value of an acceleration to be applied to the vehicle 10 if a predetermined action plan is performed, the larger the influence rate on the vehicle 10 for this predetermined action plan becomes. Similarly, the higher an absolute value of an acceleration to be applied to another vehicle if the predetermined action plan is performed is, the larger the influence rate on this vehicle for the predetermined action plan becomes. Then, based on a summation of the influence rates calculated by the influence rate calculation section 162h, the action plan is selected. In the second embodiment, there is no need for the priority ranks for the action plans to be determined in advance.

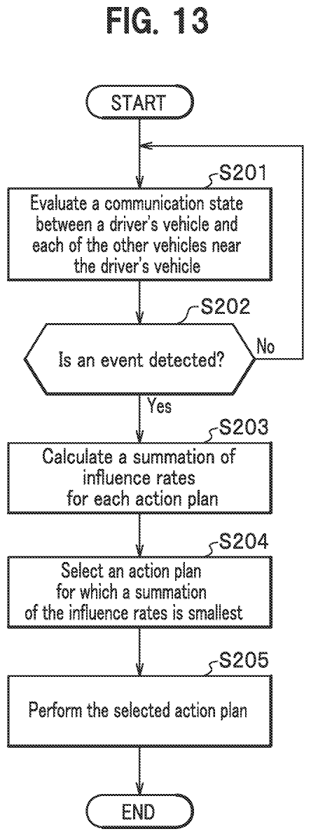

FIG. 13 is a flow chart according to which the control device 16A performs the control procedure (See FIG. 12 when necessary).

Operations of Step S201 and Step S202 in FIG. 13 are respectively the same as the operations of Step S101 and Step S102 in FIG. 5A and not explained.

If a possible event is detected in Step 202 (Yes in Step S202), the control procedure by the control device 16A proceeds to Step S203.

In Step S203, the control device 16A has the influence rate calculation section 162h calculate a summation of the influence rates for each of the plural action plans. Here, an example of the control device 16A performing the action plan as indicated in FIG. 3 is specifically explained (See FIG. 6A and FIG. 6B when necessary). In this case, the control device 16A has the influence rate calculation section 162h calculate an acceleration to be applied to the vehicle 10 (driver's vehicle) for changing lanes and calculate the influence rate for the vehicle 10 based on an absolute value of the acceleration. In the same way, the control device 16A calculates the influence rate for the vehicle 27 from an acceleration to be applied to the vehicle 27. Similarly, the influence rates are calculated for the vehicles 28, 29. As explained, the control device 16A calculates the influence rate on the vehicle 10 of the action plan Pa being performed and the influence rate on each of the other vehicles 27˜29 with which the vehicle 10 collaborates for the action plan Pa (See FIG. 4) and further calculates a summation of these influence rates.

In this case, the higher a positive acceleration is, the stronger a driver on the vehicle 10 is pressed against a seat. On the other hand, the higher a negative acceleration is, the more likely the driver on the vehicle 10 is to lean forward. Therefore, the higher an absolute value of the acceleration applied to the vehicle 10 is, the larger the influence rate on the driver becomes. Accordingly, the influence rate calculation section 162h calculates the influence rate for a predetermined action plan being performed when the predetermined action plan is performed based on the accelerations applied to the vehicle 10 and the other vehicles when the predetermined action plan is performed.

In this case, the control device 16A may calculate the influence rate on each of the other vehicles within the predetermined presence area (for example, presence area K1 in FIG. 6A) with which communication is established with the vehicle 10 (driver's vehicle).

Alternatively, the control device 16A may calculate the influence rate on each of the other vehicles in the predetermined presence area including another vehicle with which it is difficult for the vehicle 10 to communicate

In Step S204, the control device 16A has the action plan selecting section 162f select an action plan for which the summation of the influence rates is smallest. The reason for this selection is that the smaller the summation of the influence rates is, the smaller a summation of forces to be applied to drivers on the vehicle 10 and the other vehicles involved becomes.

Next, the control procedure by the control device 16A proceeds to Step S205, in which the control device 16A has the running control section 162g perform the action plan selected in Step S204, and then a series of the operations are ended (END).

<Effect>

The control device 16A of the vehicle of the second embodiment has a configuration as above described in principle. Next, actions and effects of the control device 16A are explained.

As shown in FIG. 12, the control device 16A (movable object control device) comprises a processor including an event detection section 162c detecting an occurrence of an event that influences the vehicle 10 (movable object of interest) running that is equipped with a communication section 162b through which the vehicle 10 communicate with other vehicles (other movable objects), an area determining section 162d determining a presence area where other vehicles are present with which the vehicle 10 has to communicate for each of plural action plans associated with a possible event detected by the event detection section 162c, an influence rate calculation section 162h calculating for each of the plural action plans an influence rate on each of the vehicle 10 and the other vehicles in the presence area based on accelerations to be applied to the vehicles 10 and the other vehicles in the presence area if the action plan is performed, and an action plan selecting section 162f selecting an action plan from among the plural action plans based on a result received from the influence rate calculation section 162h.

According to the configuration as described, a predetermined action plan is performed based on the summation of the influence rates on drivers of the vehicle 10 (driver's vehicle) and the other vehicles in the presence area. As a result, the influences on the drivers are reduced when the predetermined action plan is performed.

<Modified Example>

The control devices 16, 16A have been explained above. However, it is noted that the control devices 16, 16A are limited to what has been described as the control device 16 or the control device 16A and may be modified in various ways.

For instance, the embodiments described above assume that both the control devices 16, 16A include the action plan preparing section 162a (See FIG. 2). However, the control devices 16, 16A do not necessarily include the action plan preparing section 162a. That is, the control devices 16, 16A without the action plan preparing section 162a may store in the storage part 161 predetermined action plans prepared when the control devices 16, 16A are designed in advance. Alternatively, a server V (See FIG. 1) may send the information on action plans 161b and the control devices 16, 16A may receive the information on the action plans 161b and store the information in the storage part 161 (See FIG. 2).

In the case of the first embodiment, the action plans are ranked according to priority of each action plan, and in the case of the second embodiment, the action plan is selected based on how large the summation of the influence rates for each action plan is. However, the action plan may be selected in a different manner. For instance, the action plan selecting section 162f may select such an action plan as requires least other vehicles with which the vehicle 10 has to collaborate. Alternatively, the number of other vehicles and the influence rate are appropriately combined for determining the action plan.

Moreover, according to the action plans Pc, Pd (See FIG. 4), the vehicle 10 requests another vehicle running on an adjacent lane to move further away in the vehicle width direction from the vehicle 10 to temporarily be running side by side with the vehicle 10 on the adjacent lane. However, the vehicle 10 may be running side by side with another vehicle in another way. For instance, when the vehicle 10 is running on a right side or a left side lane between three lanes extending next to one another, the vehicle 10 may request that other vehicles running on the other two lanes move further away in the vehicle width direction from the vehicle 10 and three vehicles may be temporarily running side by side with one another on the other two lanes.

When the action plan Pe of the first embodiment is performed, the other vehicles 25, 26 running rearward of the vehicle 10 as well as the vehicle 10 are stopping (See FIG. 9). However, the action plan Pe can be performed in a different manner. For instance, the other vehicles 25, 26 running rearward of the vehicle 10 as well as the vehicle 10 may decelerate, which can reduce an influence caused by a possible event 8 (such as the object J being present ahead, See FIG. 3).

In the case of the second embodiment, the influence rate calculation section 162h calculates the influence rate based an absolute value of an acceleration to be applied to each of the vehicle 10 and the other vehicles involved for each predetermined action plan. However, the influence rate may be calculated based on a different parameter.

For instance, the influence calculation section 162h may calculate the influence rate based on a result of an image taken by a camera (not shown) installed in a vehicle compartment of the vehicle 10. In this case, the more likely a driver in the vehicle compartment is to be influenced by the acceleration on the vehicle, the higher value the influence calculation section 162h may set the influence rate to. Alternatively, the influence rate calculation section 162h may calculate the influence rate by combining the absolute value of the acceleration to be applied to the vehicle 10 with how the driver is influenced by the acceleration.

The vehicle 10 is not necessarily equipped with the control device 16 as described for the first embodiment. For instance, the control device 16 may be installed in a predetermined server, which is true of the control device 16A of the second embodiment.

Additionally, or alternatively, the following configuration for which, for example, the first embodiment and the second embodiment are combined, may be utilized. That is, the control device 16 of the first embodiment further may comprise an influence rate calculation section 162h calculating for each of the plural action plans influence rates on the vehicle 10 and the other vehicles in the presence area (where the other vehicles are present with which the vehicle 10 has to communicate) and assign priority ranks to the plural action plans in such a manner that the smaller a summation of the influence rates calculated for an action plan of the plural action plans by the influence rate calculation section 162h is, the higher the priority rank assigned to the action plan is.

According to this configuration, the smaller the summation of the influence rates on the vehicle 10 and the other vehicles for an action plan of the plural action plans, the higher the priority rank assigned to the action plan is. As a result, the influences on the drivers are reduced if the action plan is performed.

Additionally, at least a part of functions performed by the control device 16 or 16A of the embodiments as described may be performed by an external computer, which can communicate with the control device 16 as described in the first embodiment or the control device 16A as described in the second embodiment. Artificial intelligence (AT) may be utilized for software to perform at least a part of the functions of the control device 16.

Each of the embodiments as described can be applied to the four-wheel vehicles, the two- or three-wheel vehicle and other various vehicles (movable objects). Programs or other information for having the control method as explained for each of the embodiments executed by a computer may be stored in a storage medium such as a memory, a hard disk, an Integrated circuit card or the like.

What is claimed is:

1. A movable object control device with which a movable object of interest is equipped comprising a processor including;
an event detection section detecting a possible event that influences the movable object of interest running;
a communication section for communicating with other movable objects;
an area determining section determining a presence area for each of plural action plans associated with the possible event detected by the event detection section, the presence area being an area where other movable objects are present with which the movable object of interest needs to communicate through the communication section;
an evaluation section evaluating a communication state between the movable object of interest and each of the other movable objects included in the presence area; and
an action plan selecting section selecting an action plan to be performed from among the plural action plans based an evaluation result by the evaluation section.

2. The movable object control device as claimed in claim 1, wherein the area determining section determines the presence area based on a predetermined table that defines the presence area for each of the plural action plans.

3. The movable object control device as claimed in claim 1, wherein the event detection section determines whether the possible event requires that the movable object of interest take an emergency avoidance action, and the action plan selecting section selects an action plan from among the plural action plans for which communication is established between the movable object of interest and all of the other movable objects included in the presence area if the event detection section determines that the possible event requires that the movable object of interest take an emergency avoidance action.

4. The movable object control device as claimed in claim 1, wherein the event detection section determines whether the possible event requires that the movable object of interest take an emergency avoidance action and the communication section notifies other movable objects near the movable object of interest of the possible event if the event detection section determines that the possible event requires that the movable object of interest take an emergency action.

5. The movable object control device as claimed in claim 1, wherein the plural action plans include an action plan in which the communication section requests the other movable objects running on an adjacent lane to accelerate or decelerate to make a space between the other movable objects and the movable object of interest subsequently moves into the space between the other movable objects, when the movable object of interest is moving into the adjacent lane after the possible event is detected.

6. The movable object control device as claimed in claim 5, wherein the communication section requests that the other movable object stop a mode in which the other movable object autonomously runs to avoid contacting with an object.

7. The movable object control device as claimed in claim 1, wherein the plural action plans include an action plan in which the communication section requests the other movable object running on an adjacent lane to move further away in a width direction of the other movable object from the movable object of interest so that the movable object of interest moves into the adjacent lane and at least temporarily runs side by side with the other movable object in the adjacent lane.

8. The movable object control device as claimed in claim 1, wherein the plural action plans include an action plan in which the communication section requests that at least one of the other movable objects running on a lane on which the movable object of interest is running and located rearward of the movable object of interest stop or decelerate in conjunction with the movable object of interest after the possible event is detected.

9. The movable object control as claimed in claim 1, wherein priority ranks are assigned respectively to the plural action plans and the evaluation section evaluates the plural action plans in a sequential order according to the priority ranks from an action plan with a highest priority tank.

10. The movable object control device as claimed in claim 1,wherein the processor further comprises an influence rate calculation section calculating for each of the plural action plans an influence rate on each of the movable object of interest and the other movable objects in the presence area of the each of the plural action plans, based on accelerations to be applied to the movable object of interest and the other movable objects if the each of the plural action plans is performed, wherein priority ranks are assigned to the plural action plans in such a manner that the smaller a summation of the influence rates calculated for an action plan of the plural action plans is, the higher the priority rank assigned to the action plan becomes.

11. A movable object control device with which a movable object of interest is equipped comprising a processor including;
an event detection section detecting a possible event that influences a movable object of interest running;
a communication section for communicating with other movable objects;
an area determining section determining a presence area for each of plural action plans associated with the possible event detected by the event detection section, the presence area being an area where other movable objects are present with which the movable object of interest needs to communicate;
an influence rate calculation section calculating for each of the plural action plans influence rates on the movable object of interest and the other movable objects in the presence area of the each of the plural action plans, based on accelerations to be applied to the movable object of interest and the other movable objects if the each of the plural action plans is performed, and
an action plan selecting section selecting an action plan from among the plural action plans based on a calculated result by the influence rate calculation section.

12. A movable object control method comprising;
an event detection step of detecting a possible event that influences a movable object of interest equipped with a communication means to communicate with other movable objects;
an area determining step of determining a presence area where other movable objects are present with which the movable object of interest needs to communicate through the communication means for each of plural action plans associated with the possible event detected in the event detection step;
an evaluation step of evaluating a communication state between the movable object of interest and each of the other movable objects, and
an action plan selecting step selecting an action plan from among the plural action plans based on an evaluation result of the evaluation step.

13. A storage medium storing a program for having a computer perform the movable object control method as claimed in claim 12.
